(19) United States
(12) Patent Application Publication
(10) Pub. No.: US 2025/0299857 A1
(43) Pub. Date: Sep. 25, 2025

(54) COIL COMPONENT

(71) Applicant: TDK Corporation, Tokyo (JP)

(72) Inventors: Yusuke Nagai, Tokyo (JP); Makoto Yoshino, Tokyo (JP); Hidenobu Umeda, Tokyo (JP); Shinichi Sato, Tokyo (JP); Shingo Hattori, Tokyo (JP); Youhei Iida, Tokyo (JP); Mitsuharu Koike, Tokyo (JP); Keito Yasuda, Tokyo (JP); Takuya Miyashita, Tokyo (JP)

(73) Assignee: TDK Corporation, Tokyo (JP)

(21) Appl. No.: 19/077,352

(22) Filed: Mar. 12, 2025

(30) Foreign Application Priority Data
Mar. 21, 2024 (JP) 2024-045203

(51) Int. Cl. H01F 5/04; H01F 5/06; H01F 17/02

(52) U.S. Cl. CPC H01F 5/04; H01F 5/06; H01F 17/02

(57) ABSTRACT

A coil component includes: an element body including soft magnetic metal particles; a coil disposed inside the element body; and an external electrode connected to the coil. The external electrode includes a plated conductor at least partially embedded in the element body, and a plating layer covering the plated conductor. The plating layer is thicker than the plated conductor.

### TECHNICAL FIELD

The present disclosure relates to a coil component. The present application claims priority to Japanese Patent Application No. 2024-045203 filed on Mar. 21, 2024, the content of which is incorporated herein by reference in its entirety.

### BACKGROUND

A coil component including an element body, a coil disposed inside the element body, and an external electrode connected to the coil is known (see, for example, JP 2020-141079). JP 2020-141079 discloses that a passive component is mounted on a circuit board by the external electrode of the passive component being joined to a land pattern with solder.

### SUMMARY

A configuration in which the external electrode is embedded in the element body may be considered to suppress detachment of the external electrode from the element body. However, this configuration will reduce the distance between the external electrode and the coil, which may increase stray capacitance. Additionally, a thin external electrode may cause solder leaching.

It is an object of the present disclosure to provide a coil component that is capable of suppressing detachment of the external electrode, stray capacitance, and solder leaching.
(1) A coil component according to an embodiment of the present disclosure includes: an element body including soft magnetic metal particles; a coil disposed inside the element body; and an external electrode connected to the coil, wherein the external electrode includes a plated conductor at least partially embedded in the element body, and a plating layer covering the plated conductor, and wherein the plating layer is thicker than the plated conductor.

In the coil component above, at least a part of the plated conductor is embedded in the element body that includes soft magnetic metal particles, so that a contact area between the external electrode and the element body is increased. This suppresses the detachment of the external electrode from the element body. Additionally, the external electrode has, in addition to the plated conductor, the plating layer which is thicker than the plated conductor. This enables the thickness of the plated conductor to be reduced, so that the distance between the plated conductor and the coil can be increased. Consequently, stray capacitance can be suppressed. Furthermore, the thick plating layer can suppress solder leaching when solder mounting the coil component.
(2) In the coil component of (1) above, the plating layer may have a laminated structure in which a plurality of single plating layers are laminated, and each of the plurality of single plating layers may be thicker than the plated conductor. This makes it possible to further suppress the detachment of the external electrode, stray capacitance, and solder leaching.
(3) In the coil component of (2) above, the plating layer may include, as the plurality of single plating layers, an Ni layer, and an Sn layer disposed on the Ni layer, and the Sn layer may be thicker than the Ni layer. In this case, solder leaching can be effectively suppressed by the Ni layer, which has thermal resistance, being thick. Additionally, mounting strength can be reliably improved by the Sn layer, which has high bondability with solder, being even thicker than the Ni layer.
(4) In the coil component of any one of (1) to (3) above, an entirety of the plated conductor may be embedded in the element body. This can further suppress the detachment of the external electrode.
(5) In the coil component of any one of (1) to (4) above, the element body may include a mounting surface, and the external electrode may be provided only on the mounting surface. In this case, suppressing the detachment of the external electrode is more important compared to a configuration in which the external electrode is provided across a plurality of surfaces of the element body. Thus, the configuration in which the plated conductor is embedded in the element body is especially effective.
(6) In the coil component according to any one of (1) to (5) above, the plating layer may be provided on an outside of the element body. This can further suppress stray capacitance.

### BRIEF DESCRIPTION OF THE DRAWINGS

FIG. 1 is a perspective view of a coil component according to an embodiment.

FIG. 2 is a transparent perspective view of the coil component illustrated in FIG. 1.

FIG. 3 is an exploded perspective view of the coil component illustrated in FIG. 1.

FIG. 4 is a cross-sectional view of the coil component illustrated in FIG. 1.

### DETAILED DESCRIPTION

Embodiments of the present disclosure will be described in detail below with reference to the accompanying drawings. Same reference signs are given to the same or corresponding elements in the description of the drawings, and redundant description will be omitted.

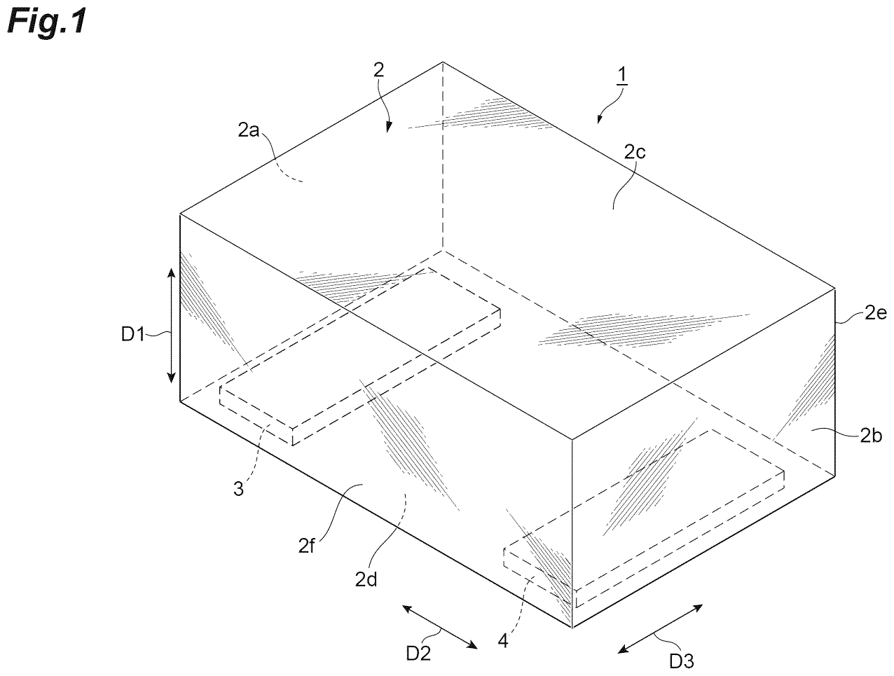

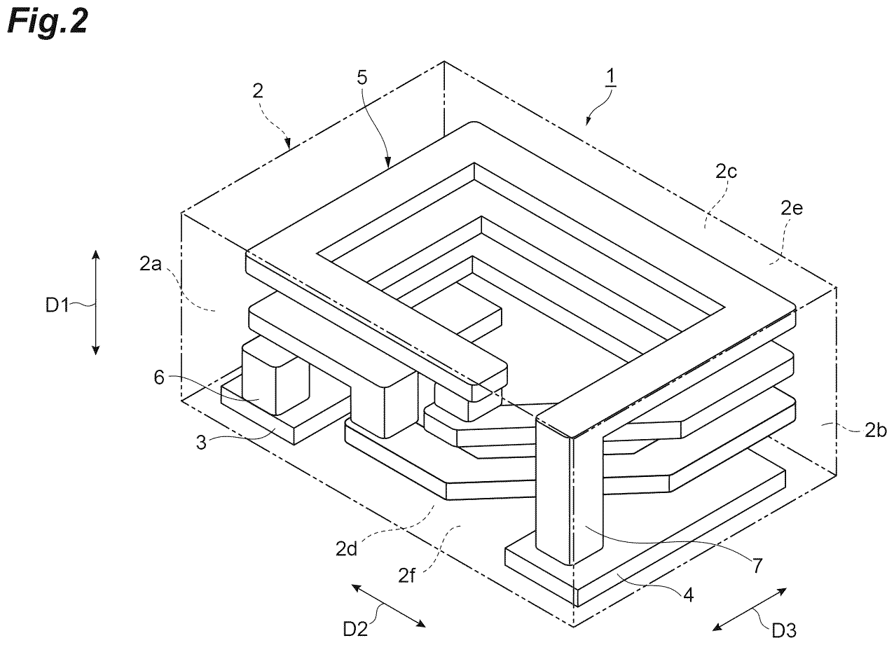

A coil component 1 according to an embodiment will be described with reference to FIGS. 1 to 4. As illustrated in FIGS. 1 to 4, the coil component 1 includes an element body 2, an external electrode 3, an external electrode 4, a coil 5, a first connecting conductor 6, and a second connecting conductor 7. The coil component 1 is a laminated coil component. In FIG. 2, the element body 2 is shown in broken lines for ease of explanation.

The element body 2 has a rectangular parallelepiped shape. The rectangular parallelepiped shape includes a rectangular parallelepiped shape in which the corners and edges are chamfered, and a rectangular parallelepiped shape in which the corners and edges are rounded. An outer surface 2s of the element body 2 has a pair of end surfaces 2a, 2b, a pair of main surfaces 2c, 2d, and a pair of side surfaces 2e, 2f. The end surfaces 2a, 2b face each other. The main surfaces 2c, 2d face each other. The side surfaces 2e, 2f face each other. In this embodiment, a facing direction of the main surfaces 2c, 2d is a first direction D1, a facing direction of the end surfaces 2a, 2b is a second direction D2, and a facing direction of the side surfaces 2e, 2f is a third direction D3. The first direction D1, the second direction D2, and the third direction D3 are substantially perpendicular to each other.

The end surfaces 2a, 2b extend in the first direction D1 so as to connect the main surfaces 2c, 2d. The end surfaces 2a, 2b also extend in the third direction D3 so as to connect the side surfaces 2e, 2f. The main surfaces 2c, 2d extend in the second direction D2 so as to connect the end surfaces 2a, 2b. The main surfaces 2c, 2d also extend in the third direction D3 so as to connect the side surfaces 2e, 2f. The side surfaces 2e, 2f extend in the first direction D1 so as to connect the main surfaces 2c, 2d. The side surfaces 2e, 2f also extend in the second direction D2 so as to connect the end surfaces 2a, 2b.

The main surface 2d is a mounting surface, and for example, when the coil component 1 is mounted on another electronic device not shown (e.g., a circuit substrate or a laminated coil component), it is the surface that faces the other electronic device. The end surfaces 2a, 2b are surfaces continuing from the mounting surface (i.e., the main surface 2d). The end surfaces 2a, 2b are also surfaces adjoining the mounting surface.

The element body 2 has a length in the second direction D2 that is greater than a length of the element body 2 in the first direction D1 and a length of the element body 2 in the third direction D3. The element body 2 has a length in the third direction D3 that is greater than the length of the element body 2 in the first direction D1. That is, in this embodiment, the end surfaces 2a, 2b, the main surfaces 2c, 2d, and the side surfaces 2e, 2f have rectangular shapes. The length of the element body 2 in the first direction D1 may be equal to or greater than the length of the element body 2 in the third direction D3.

In the description of this embodiment, the term “equal” means the same, and may also refer to values including minute differences or manufacturing errors within a preset range, and the like. For example, if a plurality of values are within a ±5% range of the average of the plurality of values, it is defined that the plurality of values are equal.

The element body 2 is formed of a plurality of element body layers (magnetic layers) 10a to 10h being laminated in the first direction D1. That is, a lamination direction of the element body 2 is the first direction D1. The specific lamination configuration will be described further below. In the actual element body 2, the plurality of element body layers 10a to 10h are integrated such that the boundaries between the layers cannot be visually recognized.

The element body 2 includes a plurality of soft magnetic metal particles P. The soft magnetic metal particles P are formed of a soft magnetic alloy (soft magnetic material). The soft magnetic alloy is, for example, an Fe—Si alloy. In the case in which the soft magnetic alloy is an Fe—Si alloy, the soft magnetic alloy may include P. The soft magnetic alloy may be, for example, an Fe—Ni—Si—M alloy. “M” includes one or more elements selected from the group consisting of Co, Cr, Mn, P, Ti, Zr, Hf, Nb, Ta, Mo, Mg, Ca, Sr, Ba, Zn, B, Al, and rare earth elements.

In the element body 2, the soft magnetic metal particles P, P are bonded. The bonding of the soft magnetic metal particles P, P is achieved, for example, by the bonding of oxide films (not shown) formed on the surfaces of the soft magnetic metal particles P. The oxide film has a thickness, for example, of 5 nm or more and 60 nm or less. The oxide film may be formed of one or a plurality of layers. A resin is present in at least a part of the gaps between the soft magnetic metal particles P, P. The resin has electrical insulation properties, and for example, may be a silicone resin, a phenol resin, an acrylic resin, or an epoxy resin.

The external electrode 3 and the external electrode 4 are provided on the element body 2, and are connected to the coil 5. The external electrode 3 and the external electrode 4 are so-called bottom electrodes, and are provided only on the mounting surface (main surface 2d). The external electrode 3 and the external electrode 4 have the same shape. The external electrode 3 and the external electrode 4 are provided on the mounting surface (main surface 2d) spaced apart from each other in the second direction D2. Specifically, the external electrode 3 is disposed closer to the end surface 2a of the element body 2, and the external electrode 4 is disposed closer to the end surface 2b of the element body 2.

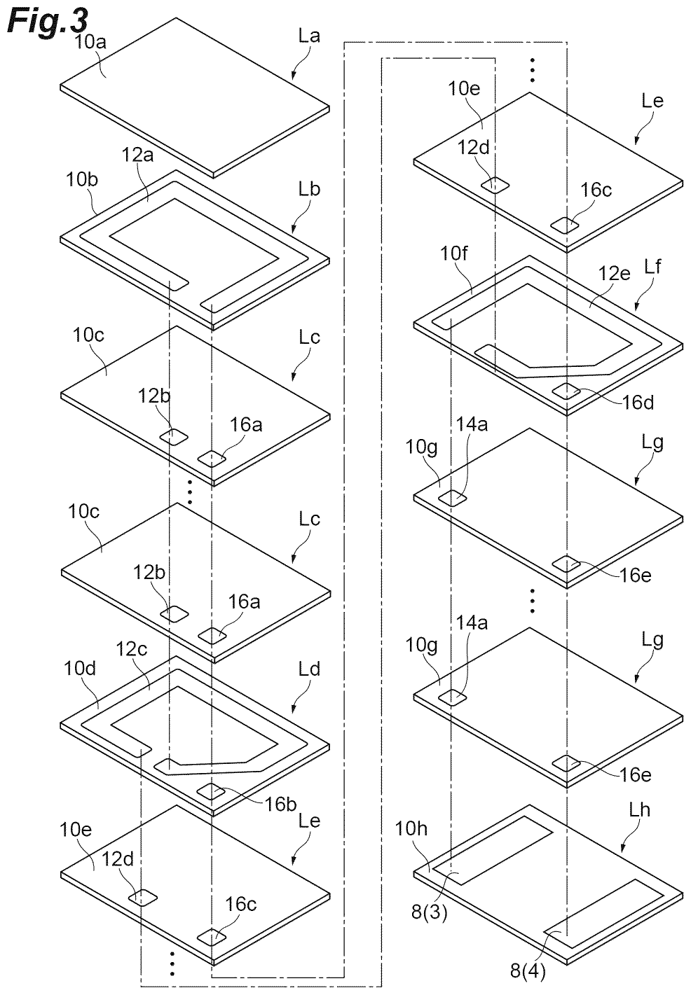

The coil 5 is disposed inside the element body 2. As illustrated in FIG. 3, the coil 5 is formed of a plurality of coil conductor layers 12a to 12e. The plurality of coil conductor layers 12a to 12e are electrically connected to each other, and form the coil 5 inside the element body 2. A coil axis of the coil 5 is provided along the first direction D1. The coil conductor layers 12a to 12e are disposed so that at least portions thereof overlap each other when viewed in the first direction D1. The plurality of coil conductor layers 12a to 12e are formed of a conductive material (e.g., Ag or Pd). In this embodiment, the plurality of coil conductor layers 12a, 12c, 12e are plated conductors. The coil conductor layers 12a to 12e are disposed spaced apart from the end surfaces 2a, 2b, the main surfaces 2c, 2d, and the side surfaces 2e, 2f.

As illustrated in FIG. 2, the first connecting conductor 6 is disposed inside the element body 2. The first connecting conductor 6 connects the external electrode 3 and the coil 5. The first connecting conductor 6 is a through hole conductor. The first connecting conductor 6 extends in the first direction D1, and is connected to the external electrode 3 and one end of the coil 5. The first connecting conductor 6 is formed of a plurality of first connecting conductor layers 14a (see FIG. 3). In this embodiment, a cross-section of the first connecting conductor 6 perpendicular to a direction of extension (first direction D1) (cross-section along the second direction D2 and the third direction D3) has a rectangular shape. That is, the first connecting conductor 6 has a rectangular prism shape.

The second connecting conductor 7 is disposed inside the element body 2. The second connecting conductor 7 connects the external electrode 4 and the coil 5. The second connecting conductor 7 is a through hole conductor. The second connecting conductor 7 extends in the first direction D1, and is connected to the external electrode 4 and the other end of the coil 5. The second connecting conductor 7 is formed of a plurality of second connecting conductor layers 16a, 16b, 16c, 16d, 16e (see FIG. 3). In this embodiment, a cross-section of the second connecting conductor 7 perpendicular to a direction of extension (first direction D1) (cross-section along the second direction D2 and the third direction D3) has a rectangular shape. That is, the second connecting conductor 7 has a rectangular prism shape.

As illustrated in FIG. 3, the coil component 1 includes a plurality of layers La, Lb, Lc, Ld, Le, Lf, Lg, Lh. The coil component 1 is formed, for example, by the layers La to Lh being laminated in order from the main surface 2c. The coil component 1 according to this embodiment includes a plurality of the layers Lc and Lg.

The layer La is formed of the element body layer 10a. The layer La forms the main surface 2c of the element body 2.

The layer Lb is formed by the element body layer 10b and the coil conductor layer 12a being combined with each other. The element body layer 10b is provided with a cutout portion (hole) (not shown) that has a shape corresponding to that of the coil conductor layer 12a, and into which the coil conductor layer 12a is fitted. The element body layer 10b has a mutually complementary relationship with the coil conductor layer 12a.

The layer Lc is formed by the element body layer 10c, the coil conductor layer 12b, and the second connecting conductor layer 16a being combined with each other. The element body layer 10c is provided with cutout portions (holes) (not shown) that have shapes corresponding to those of the coil conductor layer 12b and the second connecting conductor layer 16a, and into which the coil conductor layer 12b and the second connecting conductor layer 16a are fitted. The element body layer 10c has a mutually complementary relationship with the coil conductor layer 12b and the second connecting conductor layer 16a.

The layer Ld is formed by the element body layer 10d, the coil conductor layer 12c, and the second connecting conductor layer 16b being combined with each other. The element body layer 10d is provided with cutout portions (holes) (not shown) that have shapes corresponding to those of the coil conductor layer 12c and the second connecting conductor layer 16b, and into which the coil conductor layer 12c and the second connecting conductor layer 16b are fitted. The element body layer 10d has a mutually complementary relationship with the coil conductor layer 12c and the second connecting conductor layer 16b.

The layer Le is formed by the element body layer 10e, the coil conductor layer 12d, and the second connecting conductor layer 16c being combined with each other. The element body layer 10e is provided with cutout portions (holes) (not shown) that have shapes corresponding to those of the coil conductor layer 12d and the second connecting conductor layer 16c, and into which the coil conductor layer 12d and the second connecting conductor layer 16c are fitted. The element body layer 10e has a mutually complementary relationship with the coil conductor layer 12d and the second connecting conductor layer 16c.

The layer Lf is formed by the element body layer 10f, the coil conductor layer 12e, and the second connecting conductor layer 16d being combined with each other. The element body layer 10f is provided with cutout portions (holes) (not shown) that have shapes corresponding to those of the coil conductor layer 12e and the second connecting conductor layer 16d, and into which the coil conductor layer 12e and the second connecting conductor layer 16d are fitted. The element body layer 10f has a mutually complementary relationship with the coil conductor layer 12e and the second connecting conductor layer 16d.

The layer Lg is formed by the element body layer 10g, the first connecting conductor layer 14a, and the second connecting conductor layer 16e being combined with each other. The element body layer 10g is provided with cutout portions (holes) (not shown) that have shapes corresponding to those of the first connecting conductor layer 14a and the second connecting conductor layer 16e, and into which the first connecting conductor layer 14a and the second connecting conductor layer 16e are fitted. The element body layer 10g has a mutually complementary relationship with the first connecting conductor layer 14a and the second connecting conductor layer 16e.

The layer Lh is formed by the element body layer 10h, a plated conductor 8 of the external electrode 3, and a plated conductor 8 of the external electrode 4 being combined with each other. The element body layer 10h is provided with cutout portions (holes) (not shown) that have shapes corresponding to those of the plated conductors 8, and into which the plated conductors 8 are fitted. The element body layer 10h has a mutually complementary relationship with the plated conductor 8 of the external electrode 3 and the plated conductor 8 of the external electrode 4. The layer Lh forms the main surface 2d of the element body 2.

The external electrode 3 and the external electrode 4 will next be described in detail. The external electrode 3 and the external electrode 4 have a rectangular shape with the second direction D2 being a short side direction, and the third direction D3 being the long side direction when viewed in the first direction D1. The external electrode 3 and the external electrode 4 are disposed spaced apart from outer edges of the main surface 2d.

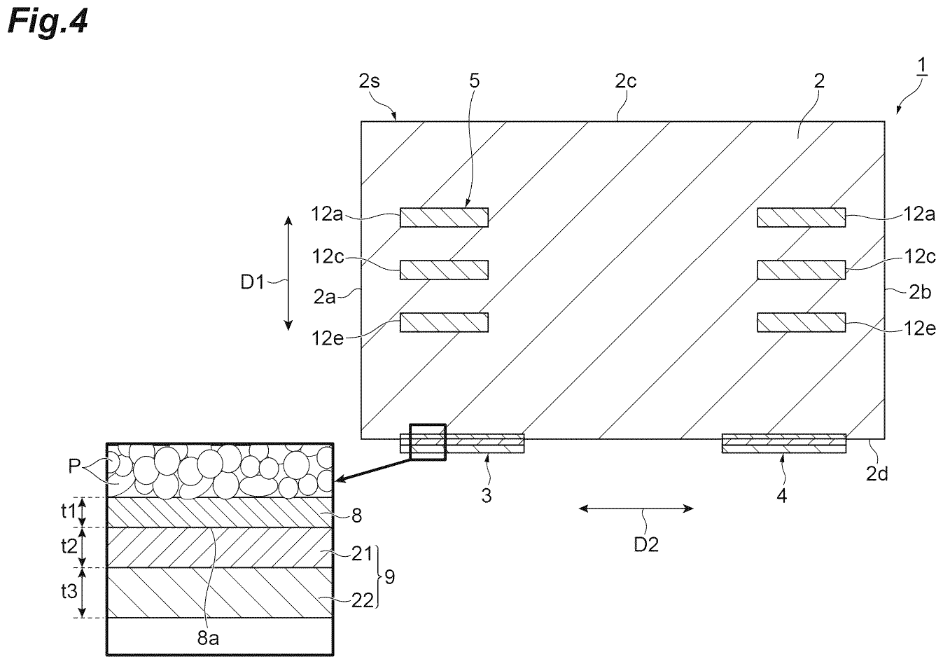

As illustrated in FIG. 4, each of the external electrodes 3, 4 has the plated conductor 8 and a plating layer 9. At least a part of the plated conductor 8 is embedded in the element body 2, and positioned inward of the outer surface 2s (here, the main surface 2d). In this embodiment, the entire plated conductor 8 is embedded in the element body 2. The plated conductor 8 has no parts disposed on the outside of the outer surface 2s (here, the main surface 2d). The plated conductor 8 has an exposed surface 8a exposed from the element body 2. In this embodiment, the exposed surface 8a of the plated conductor 8 forms the same plane as the main surface 2d. The plated conductor 8 has a single layer structure.

The plated conductor 8 is formed of a conductive material such as Ag, Cu, Ni, Sn, or Au. The plated conductor 8 does not substantially include a glass component. The content of the glass component in the plated conductor 8 is, for example, less than 0.5%. Thus, an area of a base metal material in the surface of the plated conductor 8 is larger compared to a plated conductor including a glass component. This facilitates plating formation.

The plating layer 9 covers the plated conductor 8. The plating layer 9 is, for example, not embedded in the element body 2, and is disposed on the outside of the outer surface 2s. The plating layer 9 has a laminated structure in which a plurality of single plating layers are laminated. The plating layer 9 has an Ni layer 21 and an Sn layer 22 as the plurality of single plating layers. The Ni layer 21 is disposed on the plated conductor 8. The Ni layer 21 is in contact with the exposed surface 8a and covers the entire exposed surface 8a. The Sn layer 22 is disposed on the Ni layer 21. The Sn layer 22 is disposed in contact with an outer surface of the Ni layer 21.

Each of the plurality of single plating layers is thicker than the plated conductor 8. That is, a thickness t2 of the Ni layer 21 (length of the Ni layer 21 in the first direction D1) is greater than a thickness t1 of the plated conductor 8 (length of the plated conductor 8 in the first direction D1). Additionally, a thickness t3 of the Sn layer 22 (length of the Sn layer 22 in the first direction D1) is greater than the thickness t1. The thickness t3 is, for example, greater than the thickness t2. The plating layer 9 is thicker than the plated conductor 8. That is, the total thickness of the plating layer 9 (length of the entire plating layer 9 in the first direction D1) is greater than the thickness t1.

The thickness t1 may, for example, be less than an average particle size of the soft magnetic metal particles P. The thickness t1 is, for example, 0.01 μm or more and 5 μm or less. The average particle size of the soft magnetic metal particles P is, for example, 1 μm or more and 20 μm or less. The thickness t2 is, for example, 0.5 μm or more and 5 μm or less. The thickness t3 is, for example, 1 μm or more and 10 μm or less. The total thickness of the plating layer 9 is, for example, 1.5 μm or more and 15 μm or less.

The thickness t1, the thickness t2, and the thickness t3 are obtained, for example, as described below. A cross-sectional photograph of the coil component 1 is obtained. The cross-sectional photograph is obtained, for example, by photographing a cross-section of the coil component 1 cut along a plane parallel to the side surfaces 2e, 2f and passing through the external electrodes 3, 4. The maximum thicknesses of the plated conductor 8, the Ni layer 21, and the Sn layer 22 in the obtained cross-sectional photographs are determined. Obtaining cross-sectional photographs in a similar manner by changing the position in the third direction D3 and determining the maximum thicknesses are repeated a plurality of times. Average values of each of the obtained maximum thicknesses is the thickness t1, the thickness t2, and the thickness t3.

The average particle size of the soft magnetic metal particles P is obtained, for example, as described below. A cross-sectional photograph of the coil component 1 is obtained. The obtained cross-sectional photograph is subjected to image processing by a software. Boundaries of the soft magnetic metal particles P are distinguished by the image processing, and the areas of the soft magnetic metal particles P are determined. Each particle size converted into an equivalent circle diameter is determined from the determined areas of the soft magnetic metal particles P. Here, the particle sizes of 100 or more of the soft magnetic metal particles P are calculated, and a particle size distribution of these soft magnetic metal particles P is determined. A particle size at 50% of the cumulative value of the determined particle size distribution (d50) is the “average particle size.” The particle shape of the soft magnetic metal particles P is not limited.

As described above, the entire plated conductor 8 is embedded in the element body 2 that includes the soft magnetic metal particles P in the coil component 1 according to this embodiment, so that a contact area between the external electrodes 3, 4 and the element body 2 is increased. This suppresses the detachment of the external electrodes 3, 4 from the element body 2. The external electrodes 3, 4 have, in addition to the plated conductor 8, the plating layer 9 which is thicker than the plated conductor 8. Consequently, the thickness t1 of the plated conductor 8 can be reduced. The plating layer 9 is provided on the outside of the element body 2, so that the distance between the plated conductor 8 and the coil 5 can be increased. This can suppress stray capacitance. Consequently, a self-resonant frequency (SRF) of the coil component 1 can be increased. Additionally, the thick plating layer 9 can suppress solder leaching when solder mounting the coil component 1.

The plating layer 9 has the Ni layer 21 and the Sn layer 22, and the thickness t2 of the Ni layer 21 and the thickness t3 of the Sn layer 22 are each greater than the thickness t1 of the plated conductor 8. Solder leaching can be effectively suppressed by the Ni layer 21, which has thermal resistance, being thick. Additionally, mounting strength can be reliably improved by the Sn layer 22, which has high bondability with solder, being even thicker than the Ni layer 21.

Since the external electrodes 3, 4 are provided only on the main surface 2d which is the mounting surface, the external electrodes 3, 4 are more likely to detach from the element body 2 and suppressing the detachment of the external electrodes 3, 4 is more important compared to a configuration in which the external electrodes 3, 4 are provided across a plurality of surfaces of the element body 2. Thus, the configuration in which the plated conductor 8 is embedded in the element body 2 is especially effective.

Although the embodiments have been described above, the present disclosure is not necessarily limited to these embodiments, and various modifications are possible without departing from the gist thereof.

In the embodiments above, the coil component 1 has been described as an example of the coil component. However, the coil component is not limited to the coil component 1, and may be other coil components. For example, the numbers and shapes of the coil conductors forming the coil 5 are not limited.

Although the entire plated conductor 8 is embedded in the element body 2 in the embodiments above, the plated conductor 8 may have a portion that protrudes from the outer surface 2s of the element body 2. This will facilitate the forming of the plating layer 9. The external electrodes 3, 4 may be L-shaped when viewed in the third direction D3, and may be provided also on the end surfaces 2a, 2b, in addition to the main surface 2d.

What is claimed is:

1. A coil component, comprising:
an element body including soft magnetic metal particles;
a coil disposed inside the element body; and
an external electrode connected to the coil,
wherein the external electrode includes a plated conductor at least partially embedded in the element body, and a plating layer covering the plated conductor, and
wherein the plating layer is thicker than the plated conductor.

2. The coil component according to claim 1,
wherein the plating layer has a laminated structure in which a plurality of single plating layers are laminated, and
wherein each of the plurality of single plating layers is thicker than the plated conductor.

3. The coil component according to claim 2,
wherein the plating layer includes, as the plurality of single plating layers, an Ni layer, and an Sn layer disposed on the Ni layer, and
wherein the Sn layer is thicker than the Ni layer.

4. The coil component according to claim 1, wherein an entirety of the plated conductor is embedded in the element body.

5. The coil component according to claim 1,
wherein the element body includes a mounting surface, and
wherein the external electrode is provided only on the mounting surface.

6. The coil component according to claim 1, wherein the plating layer is provided on an outside of the element body.

7. The coil component according to claim 1, wherein a thickness of the plated conductor is less than an average particle size of the soft magnetic metal particles.

8. The coil component according to claim 1, wherein a thickness of the plated conductor is 0.01 μm or more and 5 μm or less.

9. The coil component according to claim 1, wherein a thickness of the plated layer is 1.5 μm or more and 15 μm or less.

10. The coil component according to claim 1, wherein a content of a glass component in the plated conductor is less than 0.5%.

11. The coil component according to claim 1, wherein the plated conductor does not include a glass component.

12. A coil component, comprising:
an element body including soft magnetic metal particles;
a coil disposed inside the element body; and
an external electrode connected to the coil,
wherein the external electrode includes a plated conductor at least partially embedded in the element body, an Ni layer covering the plated conductor, and an Sn layer covering the Ni layer and
wherein each of the Ni layer and the Sn layer is thicker than the plated conductor.
